(19) United States
(12) Patent Application Publication
(10) Pub. No.: US 2024/0330913 A1
(43) Pub. Date: Oct. 3, 2024

(54) FACILITATING OF ELECTRONIC MESSAGE COMMUNICATIONS WITH DIFFERENT TEXTUAL ENVIRONMENTS

(71) Applicant: Truist Bank, Charlotte, NC (US)

(72) Inventors: Kendra Henry, Charlotte, NC (US); Luana Peterman, Lancaster, SC (US)

(73) Assignee: Truist Bank, Charlotte, NC (US)

(21) Appl. No.: 18/127,731

(22) Filed: Mar. 29, 2023

(51) Int. Cl. G06Q 20/38; G06Q 20/10; H04L 51/21

(52) U.S. Cl. CPC G06Q 20/386; G06Q 20/10; H04L 51/21

(57) ABSTRACT

A transaction system that facilitates the communication of transaction request electronic messages between different components or layers of the transaction system. The transaction system can include a computing device having a transaction server with a plurality of transaction initiation queues, and a customer information control system that operates on a mainframe and includes a plurality of regions. The transaction initiation queues of the transaction server may be communicatively coupled to corresponding regions of the customer information control system based on the ability of each to read or decode electronic messages having like text environments. As a result, it can be ensured that an electronic message placed in a given transaction initiation queue can be read and processed by the corresponding region of the customer information control system. This obviates the need to repeatedly reconfigure the transaction server, which improves efficiency and conserves memory and processor resources.

### TECHNICAL FIELD

The present disclosure relates generally to electronic transaction communications, and more particularly, although not exclusively, to the facilitation of transaction request communications that utilize electronic messages comprising different text environments.

### BACKGROUND

An electronic transaction, such as but not limited to a wire transaction, can be made between persons, between entities, or between some combination thereof. An electronic transaction includes one or more communications (i.e., messages) that provide various information about the electronic transaction, such as for example, sender and receiver identifying information, account information, etc. Messages associated with electronic transactions can comprise a number of different text environments based on the transaction type or otherwise. As a result, electronic transaction systems are commonly required to perform reconfiguration, translation, or other operations as electronic transaction messages are transmitted from one system component or layer to another. This is inefficient, and can also consume significant memory and processor resources.

### SUMMARY

According to one example of the present disclosure, a system may include a customer information control system operating on a mainframe and comprising a plurality of regions, and a transaction server operating on a computing device and including a plurality of transaction initiation queues, where at least some of the transaction initiation queues are communicatively coupled to corresponding regions of the customer information control system operating on the mainframe. The system may also include a processor associated with the computing device, and memory communicatively coupled to the processor, the memory including instructions that are executable by the processor to cause the processor to perform operations. The operations may include receiving, by the transaction server, an electronic message conveying a transaction request sent from a client device, determining, by the transaction server, a text environment of the electronic message, and placing the electronic message in a selected transaction initiation queue of the plurality of transaction initiation queues based on the determined text environment of the electronic message. The operations may also include transmitting the electronic message, by the selected transaction initiation queue to the corresponding region on the mainframe, to cause the customer information control system to retrieve from a database, customer information related to the transaction request. The operations may additionally include receiving, at the transaction server from the customer information control system, a response to the transaction request in the form of an electronic message that is based on the customer information retrieved by the customer information control system.

According to another example of the present disclosure, a non-transitory computer readable medium may contain instructions that are executable by a processor to cause the processor to perform operations. The operations may include receiving, by a transaction server operating on a computing device associated with the processor, an electronic message conveying a transaction request sent from a client device, determining, by the transaction server, a text environment of the electronic message, and placing the electronic message in a selected transaction initiation queue of a plurality of transaction initiation queues of the transaction server based on the determined text environment of the electronic message. The operations may also include transmitting the electronic message, by the selected transaction initiation queue, to a corresponding region of a plurality of regions of a customer information control system operating on a mainframe, to cause the customer information control system to retrieve from a database, customer information related to the transaction request. The operations may additionally include receiving, at the transaction server from the customer information control system, a response to the transaction request in the form of an electronic message that is based on the customer information retrieved by the customer information control system.

According to a further example of the present disclosure, a computer-implemented method may include receiving, by a transaction server operating on a computing device, an electronic message conveying a transaction request sent from a client device, determining, by the transaction server, a text environment of the electronic message, and placing the electronic message in a selected transaction initiation queue of a plurality of transaction initiation queues of the transaction server based on the determined text environment of the electronic message. The method may also include transmitting the electronic message, by the selected transaction initiation queue, to a corresponding region of a plurality of regions of a customer information control system operating on a mainframe, thereby causing the customer information control system to retrieve from a database, customer information related to the transaction request. The method may additionally include receiving, at the transaction server from the customer information control system, a response to the transaction request in the form of an electronic message that is based on the customer information retrieved by the customer information control system.

### BRIEF DESCRIPTION OF THE DRAWINGS

FIG. 1 is a schematic diagram representing one example of a computing environment within which electronic transaction communications can take place.

FIG. 2 is a block diagram of a system designed to facilitate the communication of electronic transaction messages between components of the transaction system, according to an example of the present disclosure.

FIG. 3 is a more detailed block diagram of a computing device of a system designed to facilitate the communication of electronic transaction messages between components of the transaction system, according to an example of the present disclosure.

FIG. 4 is a flowchart of a method of facilitating electronic transaction communications between components of a transaction system based on electronic message text environment, according to an example of the present disclosure.

### DETAILED DESCRIPTION

An electronic transaction communication environment may include a transaction system that receives transaction requests from a multitude of users employing various types of client devices, such as but not limited to, mobile devices, ATMs, etc. These client devices may communicate with the transaction system across multiple corresponding transaction channels, so that users can transmit transaction requests such as, for example, payment or fund transfer requests, to an entity for processing.

Transaction systems may be complex, having multiple components and applications that can reside at different locations and depend on proper communications and interactions therebetween for successful transaction processing. Additionally, a transaction system may be required to process transactions conveyed via electronic messages comprising a myriad of text environments, which can require the repeated reconfiguration of one or more transaction system components to match the varying text environments of newly received electronic messages. This repeated reconfiguration of one or more transaction system components is inefficient, and can also consume significant memory and processor resources.

Aspects of the present disclosure are directed to a transaction system designed to facilitate the communication of transaction electronic messages comprising different text environments between multiple transaction system components or layers. In this regard, a system according to the present disclosure may include a transaction server that operates on a computing device and receives transaction requests in the form of electronic messages comprising different text environments. The transaction server can include one or more transaction initiation queues into which transaction electronic messages received by the transaction server may be temporarily placed.

The system may further include a customer information control system operating on a mainframe and comprising a plurality of regions. Each region of the customer information control system may include one or more programs or applications that perform various functions associated with the processing of transaction requests. For example, a customer information control system region may be operative to retrieve information, such as customer information, associated with a transaction request received at the transaction server and subsequently transmitted to the customer information control system, and to provide a response to a transaction request based on the retrieved information.

Each transaction initiation queue of the transaction server can include programming for reading or otherwise decoding electronic messages comprising a particular text environment. Likewise, each region of the customer information control system can include programming for reading or otherwise decoding electronic messages comprising a particular text environment.

It is desirable to avoid reconfiguration of the transaction server when transmitting transaction request electronic messages comprising different text environments to the customer information control system. Consequently, each transaction initiation queue (or multiple like-configured transaction initiation queues) of the transaction server on the computing device can be communicatively coupled to a corresponding region (or multiple like-configured regions) of the customer information control system on the mainframe. A “corresponding region” according to the present disclosure is a region of the customer information control system that reads or decodes electronic messages comprising the same text environment that is read or decoded by the transaction initiation queue to which the region is communicatively coupled. The communicative coupling between a given transaction initiation queue of the transaction server and a corresponding region of the customer information control system is preferably a configured static connection to allow for repeatable communication therebetween of electronic messages comprising a given text environment without the need for any reconfiguration of the transaction server.

Thus, when the transaction server of a system according to the present disclosure receives a transaction request electronic message, the transaction server can determine the text environment of the electronic message and then automatically select a transaction initiation queue in which to temporarily place the electronic message based on the text environment of the electronic message. That is, the transaction server can select a transaction initiation queue into which to place a given electronic message by matching the text environments of the electronic message and the transaction initiation queue. Since the transaction initiation queue is also communicatively coupled to a corresponding customer information control system region that reads or decodes electronic messages comprising the same text environment that is read or decoded by the transaction initiation queue, it can be assured that the customer information control system can properly receive and read an electronic message transmitted thereto.

The following illustrative examples are provided to introduce the reader to the general subject matter discussed herein, and are not intended to limit the scope of the disclosed concepts. In the following description, specific details are set forth in order to provide a thorough understanding of various implementations and examples. Various implementations may be practiced without these specific details. The figures and description are not intended to be restrictive.

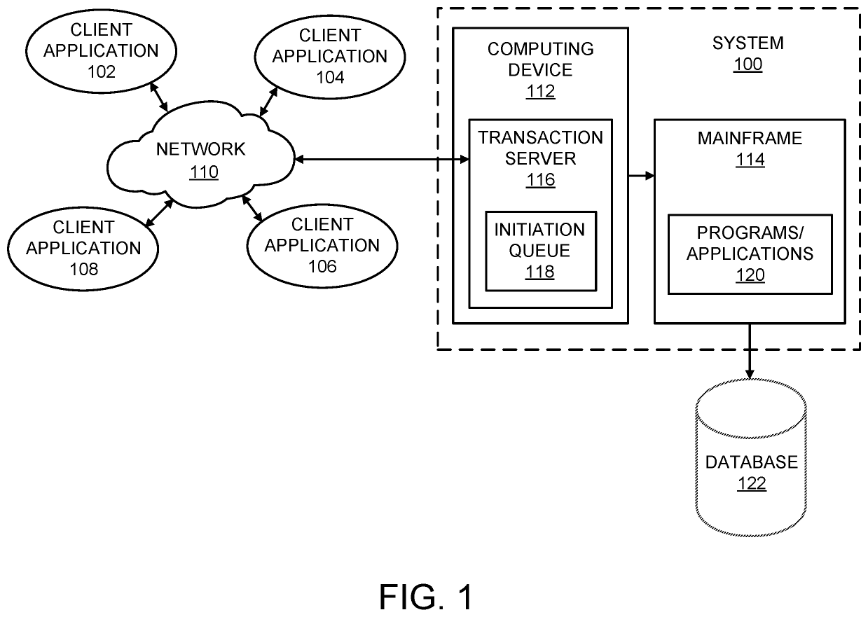

FIG. 1 is a schematic block diagram representing one example of a computing environment including a transaction system 100 to which users can transmit transaction requests for processing via a multitude of different client applications 102, 104, 106, 108 running on numerous types of client devices. The transaction requests may be transmitted by the client applications 102, 104, 106, 108 to the transaction system 100 over a network 110. The network 110 may be without limitation, a local area network (LAN), a wide-area network (WAN) such as the Internet, an institutional network, cellular or other wireless networks, virtual networks such as an intranet or an extranet, etc.

The transaction system 100 can include a computing device 112 and a mainframe 114 to which the computing device 112 may be communicatively coupled. A transaction server 116 may operate on the computing device 112 and may receive the transaction requests from the client applications 102, 104, 106, 108. The transaction server 116 can include at least one, but will more likely include a plurality, of transaction initiation queues 118 into which the transaction server 116 can temporarily place received transaction requests for subsequent processing by the mainframe 114.

A number of different programs or applications 120 may operate on the mainframe 114. The programs or applications 120 may operate to perform various functions relative to processing of a transaction request, such as but not limited to, data retrieval, authentication, authorization, or other verification functions associated with a customer or a transaction. As described in more detail below, the programs or applications 120 may be components of a customer information control system. The mainframe 114 may also be communicatively coupled to a database 122 from which the programs or applications 120 operating on the mainframe 114 can retrieve or store information, such as customer information.

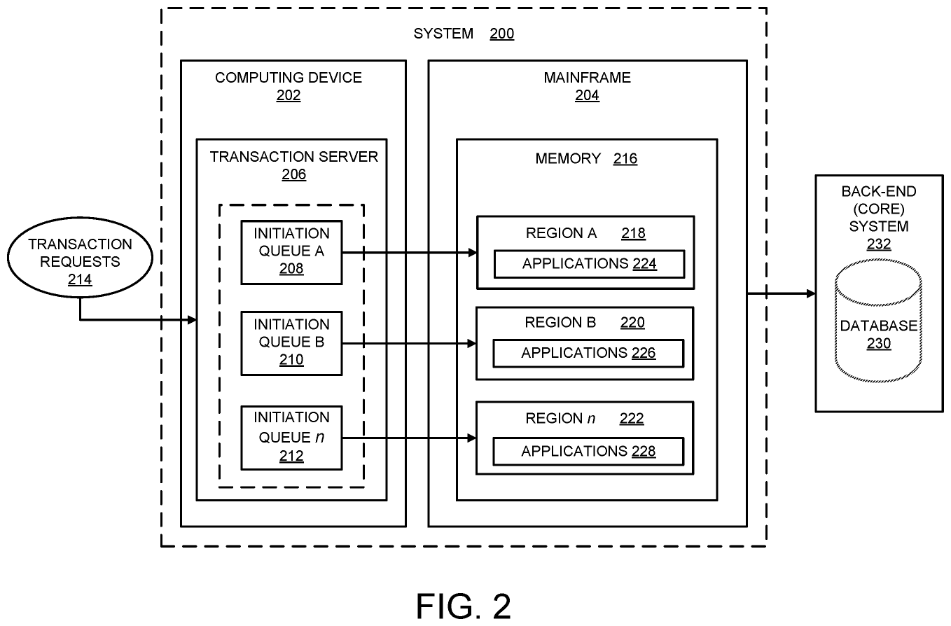

FIG. 2 is a more detailed block diagram of a transaction system 200 designed to facilitate the communication of transaction electronic messages between components of the transaction system, according to an example of the present disclosure. As shown, the transaction system 200 again includes a computing device 202 and a mainframe 204.

Operating on the computing device 202 is a transaction server 206. The transaction server 206 can include a plurality of transaction initiation queues, represented in FIG. 2 by transaction initiation queues 208-304. A greater or lesser number of transaction initiation queues may be present in other examples of a transaction system according to the present disclosure. When the transaction server 206 receives a transaction request electronic message 214 from a customer or another user, the transaction server 206 can temporarily place the electronic message into one of the transaction initiation queues 208, 210, 212 to await subsequent processing by the mainframe 204.

The mainframe 204 can be observed to include a memory 216. A customer information control system may operate within the memory 216 of the mainframe 204. The customer information control system may comprise a plurality of regions, represented in FIG. 2 by regions 218-222. A greater or lesser number of regions may be present in other examples of a transaction system according to the present disclosure. A number of programs or applications 224, 226, 228 may respectively operate within the regions 218, 220, 222 of the customer information control system for purposes of processing transaction requests and otherwise.

As explained above, transaction requests 214 are received by the transaction server 206 of the computing device 202 in the form of electronic messages. The electronic messages can comprise different text environments. While the programs or applications 224, 226, 228 operating in one or more of the regions 218, 220, 222 of the customer information control system may be programmed or otherwise configured to read or decode an electronic message comprising a particular text environment, the programs or applications 224, 226, 228 operating in other regions 218, 220, 222 of the customer information control system may not be compatible with the particular text environment of a given electronic message. Therefore, as represented in FIG. 2, in order to avoid the need to reconfigure the transaction server 206 when transmitting transaction request electronic messages comprising different text environments to different regions 218, 220, 222 of the customer information control system, a transaction initiation queue 208, 210, 212 of the transaction server 206 that is programmed or otherwise configured to read or decode electronic messages comprising a particular text environment can be communicatively coupled to a corresponding region 218, 220, 222 of the customer information control system that is likewise programmed or otherwise configured to read or decode electronic messages comprising the same text environment.

The communicative coupling between a given transaction initiation queue of the transaction server and a corresponding region of the customer information control system is preferably a configured static connection. This ensures that when the transaction server 206 places a transaction request electronic message into a selected transaction initiation queue of the plurality of transaction initiation queues 208, 210, 212, the electronic message will be readable and processible by the programs or applications 224, 226, 228 operating in the region 218, 220, 222 of the customer information control system to which the selected transaction initiation queue is communicatively coupled.

The programs or applications 224, 226, 228 of a given region 218, 220, 222 of the customer information control system may perform various transaction processing operations. For example, the programs or applications 224, 226, 228 may retrieve information, such as customer information, or may perform authentication, authorization, or other verification functions, etc. To this end, the customer information control system operating on the mainframe 204 may be communicatively coupled to a database 230, from which the programs or applications 224, 226, 228 of the customer information control system may retrieve customer or other information required to process received transaction requests. The database 230 may be associated with a back-end computing system 232 of the processing entity in at least some examples.

The customer information control system may also provide to the transaction server 206, a response to a transaction request. The response may be based at least in part on information retrieved by the customer information control system from the database 230. For example, the customer information control system may send a response that approves or denies a transaction, requests additional information, etc. The response can be sent as an electronic message.

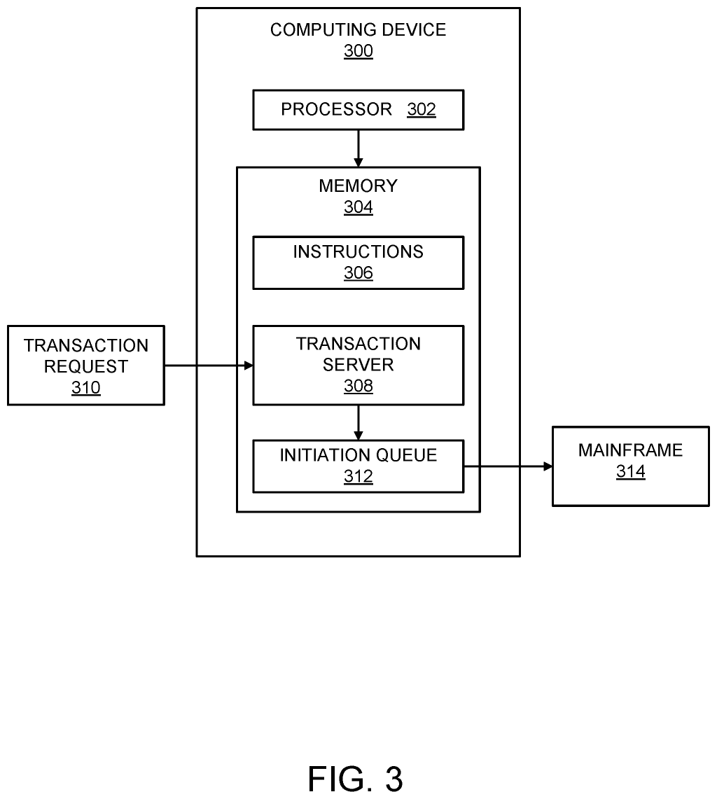

FIG. 3 is a block diagram depicting various components of one example of a computing device of a transaction system according to the present disclosure. As depicted, the computing device 300 may include a processor 302 that is communicatively coupled to a memory 304.

The processor 302 can include one processing device or multiple processing devices. Non-limiting examples of the processor 302 include a Field-Programmable Gate Array (FPGA), an application-specific integrated circuit (ASIC), a microprocessor, etc.

The memory 304 can include one memory or multiple memories. The memory 304 can be non-volatile and may include any type of memory that retains stored information when powered off. Non-limiting examples of the memory 304 include electrically erasable and programmable read-only memory (EEPROM), flash memory, or any other type of non-volatile memory. At least some of the memory 304 can be a non-transitory computer-readable medium from which the processor 302 can read instructions 306. A computer-readable medium can include electronic, optical, magnetic, or other storage devices capable of providing the processor 302 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 302 can read the instructions 306.

In some examples, the instructions 306 can include processor-specific instructions generated by a compiler or an interpreter from code written in a suitable computer-programming language, such as C, C++, C#, etc. The processor 302 can execute the instructions 306 stored in the memory 304 to perform operations. For example, executing the instructions 306 can cause the processor 302 to direct a transaction server 308 of the computing device 300 to receive a transaction request electronic message 310 from a customer, and to temporarily place the transaction request electronic message in a selected transaction initiation queue 312 of a plurality of transaction initiation queues in the manner described above. Executing the instructions 306 can also cause the processor 302 to direct the transaction server 308 to transmit a transaction request electronic message to a corresponding region of a customer information control system operating on a mainframe 314 as described above (or to allow the customer information control system to retrieve the transaction request electronic message from the selected transaction initiation queue 312).

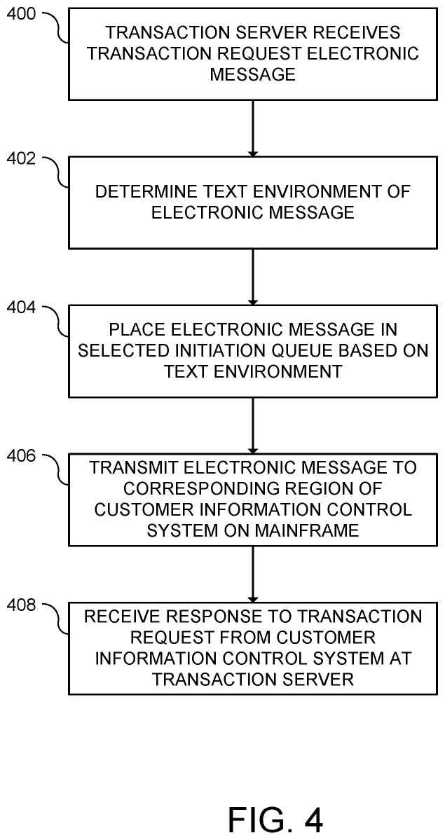

FIG. 4 is a flowchart illustrating one example of a computer-implemented method of facilitating the communication of electronic transaction messages between components of a transaction system, according to an example of the present disclosure. As represented, at block 400, a transaction server operating on a computing device of the transaction system receives a transaction request electronic message. At block 402, the transaction server determines a text environment of the electronic message. At block 404, the transaction server places the electronic message in a selected transaction initiation queue of a plurality of transaction initiation queues of the transaction server based on the determined text environment of the electronic message. Subsequently thereto, the selected transaction initiation queue transmits, at block 406, the electronic message to a corresponding region of a plurality of regions of a customer information control system operating on a mainframe, which causes the customer information control system to retrieve from a database, customer information related to the transaction request. At block 408, the transaction server receives from the customer information control system, a response to the transaction request in the form of an electronic message that is based on the retrieved customer information.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system, comprising:
a customer information control system operating on a mainframe and comprising a plurality of regions;
a transaction server operating on a computing device and including a plurality of transaction initiation queues, at least some of the transaction initiation queues communicatively coupled to corresponding regions of the customer information control system operating on the mainframe;
a processor associated with the computing device; and
memory communicatively coupled to the processor, the memory including instructions that are executable by the processor to cause the processor to:
receive, via the transaction server, an electronic message conveying a transaction request sent from a client device;
determine, by the transaction server, a text environment of the electronic message;
place the electronic message in a selected transaction initiation queue of the plurality of transaction initiation queues based on the determined text environment of the electronic message;
transmit the electronic message, by the selected transaction initiation queue to a corresponding region on the mainframe, to cause the customer information control system to retrieve from a database, customer information related to the transaction request; and
receive, at the transaction server from the customer information control system, a response to the transaction request that is sent as an electronic message and based on the customer information retrieved by the customer information control system.

2. The system of claim 1, wherein each region of the customer information control system supports a different electronic message text environment.

3. The system of claim 2, wherein the memory includes instructions that are executable by the processor to cause the transaction server to select a transaction initiation queue within which to place the electronic message based on the electronic message text environment supported by the customer information control system region to which the transaction initiation queue is communicatively coupled.

4. The system of claim 2, wherein the memory includes instructions that are executable by the processor to cause the customer information control system to transmit a response to the transaction request, the response comprising an electronic message having the same text environment as the electronic message received by the transaction server from the client device.

5. The system of claim 1, wherein a given transaction initiation queue and a corresponding region to which the transaction initiation queue is communicatively coupled, each include programming for reading or decoding electronic messages having the same text environment.

6. The system of claim 1, wherein a given transaction initiation queue and a corresponding region are statically coupled, and no reconfiguration of the transaction initiation queue is required to transmit the electronic message from the transaction initiation queue to the corresponding region.

7. The system of claim 1, wherein the database is part of a back-end computing system to which the customer information control system is communicatively coupled.

8. A non-transitory computer-readable medium comprising instructions that are executable by a processor for causing the processor to:
receive, by a transaction server operating on a computing device associated with the processor, an electronic message conveying a transaction request sent from a client device;
determine, by the transaction server, a text environment of the electronic message;
place the electronic message in a selected transaction initiation queue of a plurality of transaction initiation queues of the transaction server based on the determined text environment of the electronic message;
transmit the electronic message, by the selected transaction initiation queue, to a corresponding region of a plurality of regions of a customer information control system operating on a mainframe, to cause the customer information control system to retrieve from a database, customer information related to the transaction request; and
receive, at the transaction server from the customer information control system, a response to the transaction request that is sent as an electronic message and based on the customer information retrieved by the customer information control system.

9. The non-transitory computer-readable medium of claim 8, wherein each region of the customer information control system supports a different electronic message text environment.

10. The non-transitory computer-readable medium of claim 9, wherein the instructions of the non-transitory computer-readable medium are executable by the processor to cause the transaction server to select a transaction initiation queue within which to place the electronic message based on the electronic message text environment supported by the corresponding region of the customer information control system.

11. The non-transitory computer-readable medium of claim 9, wherein the instructions of the non-transitory computer-readable medium are executable by the processor to cause the customer information control system to transmit a response to the transaction request, the response comprising an electronic message having the same text environment as the electronic message received by the transaction server from the client device.

12. The non-transitory computer-readable medium of claim 8, wherein a given transaction initiation queue of the transaction server and a corresponding region of the customer information control system each include programming for reading or decoding electronic messages having the same text environment.

13. The non-transitory computer-readable medium of claim 8, wherein a given transaction initiation queue and a corresponding region are statically coupled, and no reconfiguration of the transaction initiation queue is required to transmit the electronic message from the transaction initiation queue to the corresponding region.

14. The non-transitory computer-readable medium of claim 8, wherein the database is part of a back-end computing system to which the customer information control system is communicatively coupled.

15. A computer-implemented method comprising:
receiving, by a transaction server operating on a computing device, an electronic message conveying a transaction request sent from a client device;
determining, by the transaction server, a text environment of the electronic message;
placing the electronic message in a selected transaction initiation queue of a plurality of transaction initiation queues of the transaction server based on the determined text environment of the electronic message;
transmitting the electronic message, by the selected transaction initiation queue, to a corresponding region of a plurality of regions of a customer information control system operating on a mainframe, thereby causing the customer information control system to retrieve from a database, customer information related to the transaction request; and
receiving, at the transaction server from the customer information control system, a response to the transaction request that is sent as an electronic message and based on the customer information retrieved by the customer information control system.

16. The method of claim 15, wherein each region of the customer information control system is programmed to read or decode a different electronic message text environment.

17. The method of claim 16, wherein the transaction server selects a transaction initiation queue within which to place the electronic message based on the electronic message text environment supported by the corresponding region of the customer information control system.

18. The method of claim 16, wherein the customer information control system transmits a response to the transaction request comprising an electronic message having the same text environment as the electronic message received by the transaction server from the client device.

19. The method of claim 15, wherein a given transaction initiation queue of the transaction server and a corresponding region of the customer information control system each read or decode electronic messages having the same text environment.

20. The method of claim 15, wherein no reconfiguration of the transaction initiation queue is required to transmit the electronic message from the selected transaction initiation queue to the corresponding region.
